(19) United States
(12) Patent Application Publication
(10) Pub. No.: US 2026/0144701 A1
(43) Pub. Date: May 28, 2026

(54) Hands-Free And Multi-Angle Adjustable Adult Product Device

(71) Applicant: YOULI WANG, Guang'an Cty (CN)

(72) Inventor: YOULI WANG, Guang'an Cty (CN)

(21) Appl. No.: 18/963,531

(22) Filed: Nov. 28, 2024

(51) Int. Cl. A61H 19/00; A61H 23/02

(52) U.S. Cl. CPC A61H 19/32; A61H 19/44; A61H 23/0254; A61H 2201/0119; A61H 2201/0192; A61H 2201/1673

(57) ABSTRACT

A hands-free and multi-angle adjustable adult product device, comprising: a support member, wherein the support member is provided with a wearing structure; a rotation adjustment mechanism, which includes a rotating component mounted on the support member and capable of rotating around the X-axis to adjust the angle, a locking component installed within the support member, and an elastic component disposed between the inner wall of the support member and the locking component, wherein the locking component engages and locks with the rotating component under the elastic force of the elastic component, and an unlock button connected to the locking component is exposed on the surface of the support member; a connecting arm, comprising at least two segments assembled together and capable of rotating around the Z-axis to adjust the angle.

### FIELD OF THE INVENTION

This invention pertains to the technical field of adult products, specifically to a hands-free and multi-angle adjustable adult product device.

### BACKGROUND OF THE INVENTION

Adult products refer to auxiliary tools that help adults achieve sexual assistance, not only enhancing sexual interest and improving the quality of sexual life but also bringing positive effects on sexual health. These comprise products such as male masturbators, vibrators, lingerie, and love eggs.

Among them, the male masturbator is a tubular object made by molding soft silicone or rubber materials to mimic the shape of female genitalia. It uses an electric/pneumatic mechanism for reciprocating mechanical movement to massage the male genitalia, serving as a tool for adult males. However, during use, male masturbators generally require both hands to hold the device for an extended period, which can lead to hand fatigue and affect the user experience. Additionally, this lack of hands-free capability prevents users from engaging in other activities, making it inconvenient to use.

In view of the above, the inventor has proposed the following technical solution.

### SUMMARY OF THE INVENTION

The purpose of this invention is to overcome the deficiencies of prior art by providing a hands-free and multi-angle adjustable adult product device.

To solve the above technical problem, the invention adopts the following technical solution: The hands-free and multi-angle adjustable adult product device comprises: a support member, equipped with a wearing structure for securing to the human body; a rotation adjustment mechanism, including a rotating component mounted on the support member and capable of rotating around the X-axis to adjust the angle, a locking component installed movably back and forth within the support member, and an elastic component located between the inner wall of the support member and the locking component. The locking component engages with and locks the rotating component under the elastic force of the elastic component, with an unlock button connected to the locking component exposed on the support member's surface. When the unlock button is pressed, the locking component is moved backward to disengage from the rotating component, allowing the rotating component to rotate relative to the support member to adjust the angle. A connecting arm, consisting of at least two sections—the first arm and the second arm—installed together and capable of rotating around the Z-axis to adjust the angle. The first arm is mounted on the rotating component and can rotate around the Z-axis to adjust the angle. The distal end of the second arm is equipped with an adult product tool or a holder for fixing and installing the adult product tool.

Further, in the above technical solution, the rear end of the rotating component is equipped with a first locking groove, and the inner wall of the first locking groove is provided with multiple first locking teeth. The front end of the locking component has a locking protrusion compatible with the first locking groove, and the outer surface of the locking protrusion is equipped with second locking teeth compatible with the first locking teeth. When the locking protrusion is inserted into the first locking groove, the second locking teeth engage with the first locking teeth to lock the rotating component at the front end of the locking component.

Further, in the above technical solution, the support member is equipped with a mounting cylinder. The mounting cylinder comprises a first polygonal groove, and the opening of the mounting cylinder is provided with a circular groove that communicates with the first polygonal groove. The locking component has a polygonal cross-section compatible with the first polygonal groove and is embedded in the first polygonal groove for back-and-forth movement. The rear end of the rotating component is circular, embedded in the circular groove, and capable of rotation.

Further, in the above technical solution, the support member is also equipped with a guide cylinder. The guide cylinder comprises a sliding guide groove that communicates with the first polygonal groove of the mounting cylinder. A connecting rod integrally connects the locking component and the unlock button, with the connecting rod and the rear end of the unlock button configured for installation within the sliding guide groove.

Further, in the above technical solution, the rotating component consists of a rotating base and a rotating plate fixed to the rear end of the rotating base via a first screw. The rear end of the rotating base is mounted in a first rotating groove on the surface of the support member. The rotating plate is located inside the support member. The rotating base and the rotating plate are installed on the support member by clamping together in a front-to-back manner, forming a rotatable assembly. The rear end of the rotating plate is equipped with the aforementioned first locking groove.

Further, in the above technical solution, the rear end of the rotating base is provided with a convex seat, which comprises a second polygonal groove and a threaded hole located at the center of the second polygonal groove. The front end of the rotating plate is provided with a first limiting groove compatible with the convex seat and a polygonal convex ring at the center of the first limiting groove. The polygonal convex ring has a countersunk hole at its center for installing the first screw. The rotating base is embedded in the first limiting groove via the convex seat. The polygonal convex ring is embedded in the threaded hole, and the countersunk hole aligns with the threaded hole. The first screw passes through the countersunk hole and the threaded hole to fix the rotating base and the rotating plate together, preventing relative rotation.

Further, in the above technical solution, the support member consists of a front shell and a rear shell fixed to the rear end of the front shell. The wearing structure comprises a first binding strap and a second binding strap. One end of the first binding strap is fixed to one side of the support member, and one end of the second binding strap is fixed to the other side. The other ends of the first and second binding straps are secured to each other through magnetic attraction, snap fasteners, or Velcro to form a wearing space with the support member.

Further, in the above technical solution, the first arm and the rotating component are connected through a joint assembly to form a rotatable connection. Specifically, the front end of the rotating component is equipped with a pivot hole, and both sides of the rotating component are provided with polygonal anti-rotation grooves and first holes that communicate with the pivot hole. The rear end of the first arm is equipped with a pivot section, which comprises a first shaft hole running through its sides. The inner wall of one side of the first shaft hole is provided with a second locking groove, and the inner wall of the second locking groove is equipped with multiple third locking teeth. The joint assembly comprises an anti-rotation locking block, a first spring, and a shaft rod. The anti-rotation locking block comprises a polygonal anti-rotation section and a locking section. The locking section is externally equipped with multiple fourth locking teeth compatible with the third locking teeth. The polygonal anti-rotation section is embedded in the polygonal anti-rotation groove, while the locking section is inserted into the second locking groove, with the fourth locking teeth engaging the third locking teeth. One end of the shaft rod is formed into a button section, while the other end of the shaft rod passes through the first hole, pivot hole, and first shaft hole to connect with the locking section. It is locked with the locking section using a second screw. The first spring is sleeved over the shaft rod, with both ends of the spring pressing against the button section and the pivot section, and it is kept in a compressed state.

Further, in the above technical solution, both sides of the front end of the rotating component are additionally equipped with a first end cover and a second end cover. The first end cover encloses the shaft rod and its button section, and the first end cover comprises a first sliding hole. The button section is configured to slide within the first sliding hole and is exposed on the surface of the first end cover. The second end cover encloses the anti-rotation locking block. The assembly structure between the first arm and the second arm is identical to the assembly structure between the rotating component and the first arm.

Further, in the above technical solution, the adult product tool or holder can rotate relative to the second arm around the Z-axis to adjust the angle. The assembly structure between the second arm and the adult product tool or holder is identical to the assembly structure between the rotating component and the first arm.

After adopting the above technical solution, compared with the prior art, the invention has the following beneficial effects: During use, the wearing structure works in conjunction with the support member to secure the device to the human body. The adult product tool can rotate relative to the support member around the X-axis via the rotation adjustment mechanism to adjust the angle. It can also rotate relative to the rotation adjustment mechanism around the Z-axis through the connecting arm to adjust the angle, achieving multi-angle adjustment. This allows the adult product tool to be positioned at a predetermined location, facilitating its use without requiring the user to hold it continuously with both hands. Thus, it frees the hands, achieving hands-free operation. This not only avoids the fatigue caused by holding the adult product tool but also enhances the user experience, as the user can use their hands for other activities.

### BRIEF DESCRIPTION OF THE DRAWINGS

FIG. 1 is a perspective view of the invention;

FIG. 2 is an assembly view of the front shell and the wearing structure of the invention;

FIG. 3 is a cross-sectional view of the invention (joint assembly in the locked state);

FIG. 4 is a cross-sectional view of the invention (joint assembly in the unlocked state);

FIG. 5 is an exploded perspective view of the invention;

FIG. 6 is a perspective view of the rotation adjustment mechanism of the invention;

FIG. 7 is a perspective view of the locking component of the invention;

FIG. 8 is another perspective view of the locking component of the invention;

FIG. 9 is a perspective view of the rotating plate of the invention;

FIG. 10 is another perspective view of the rotating plate of the invention;

FIG. 11 is a perspective view of the rotating base of the invention;

FIG. 12 is an assembly view of the rotating base, first arm, and joint assembly of the invention;

FIG. 13 is a perspective view of the front cover of the invention;

FIG. 14 is a perspective view of a second structure of the invention;

FIG. 15 is a perspective view of a third structure of the invention.

### DETAILED DESCRIPTION OF THE EMBODIMENTS

The invention is further explained below in conjunction with specific embodiments and accompanying drawings.

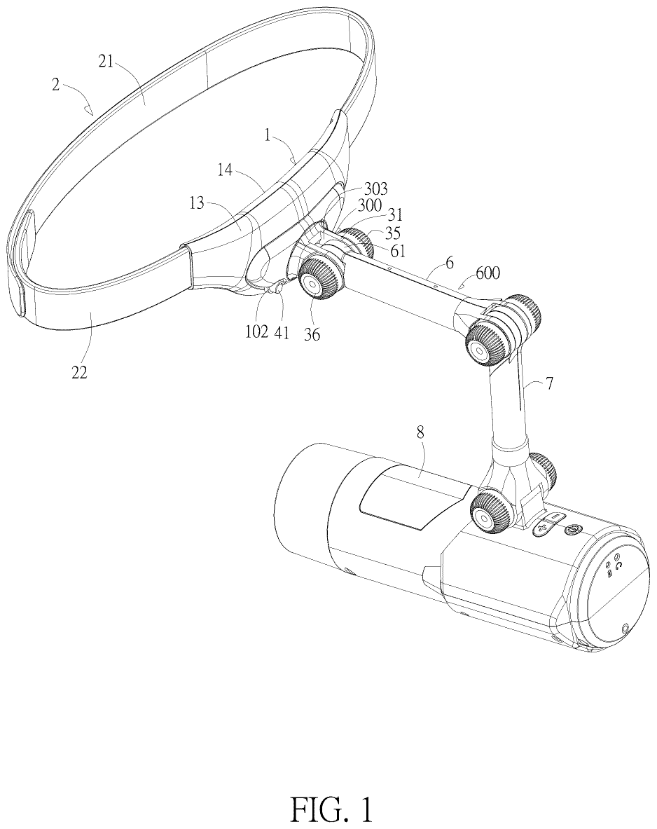

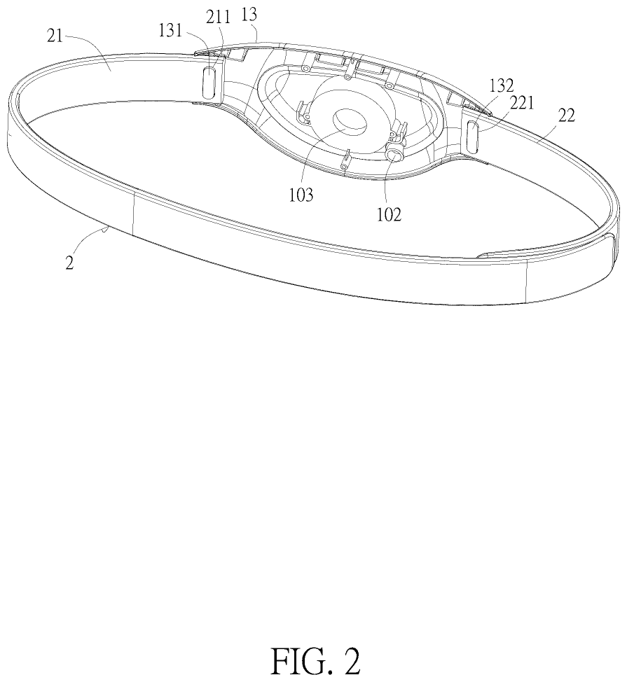

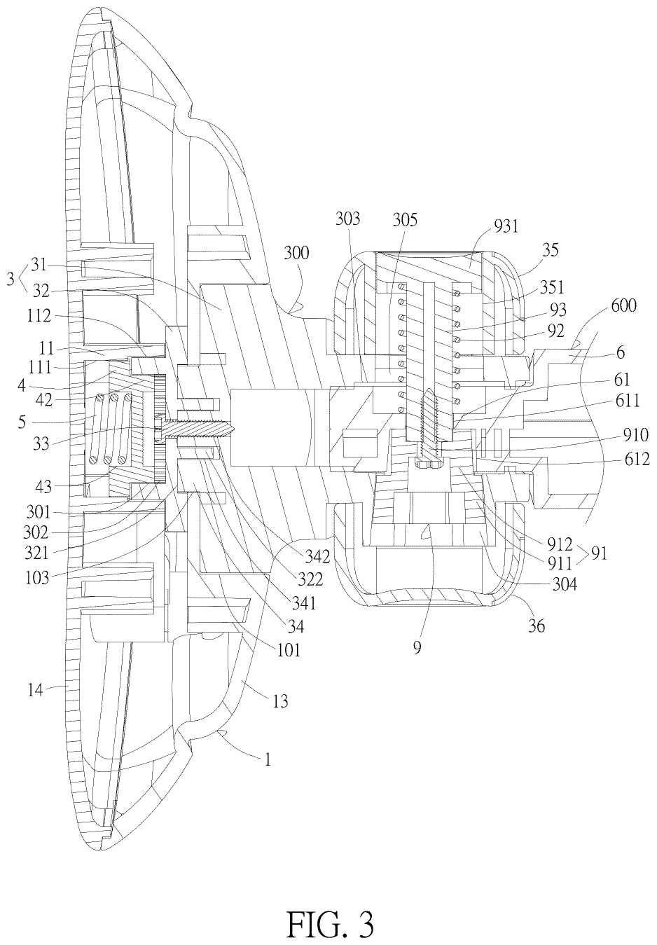

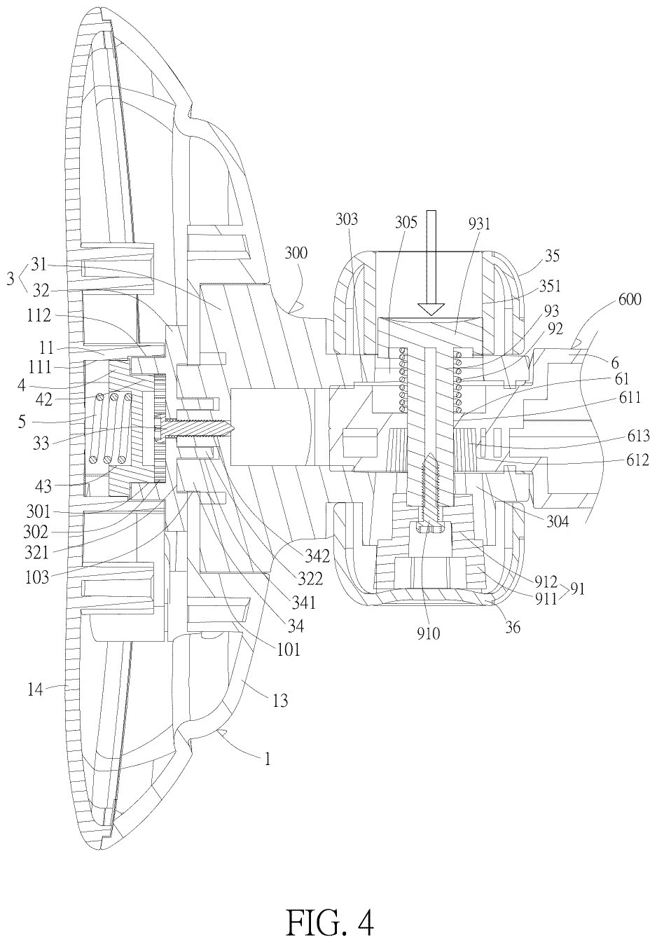

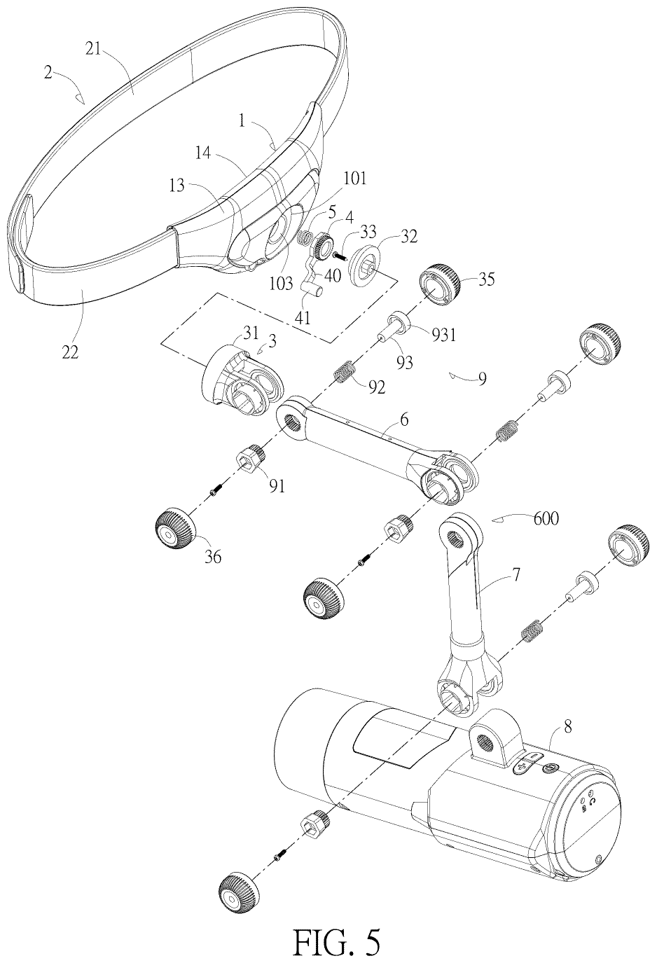

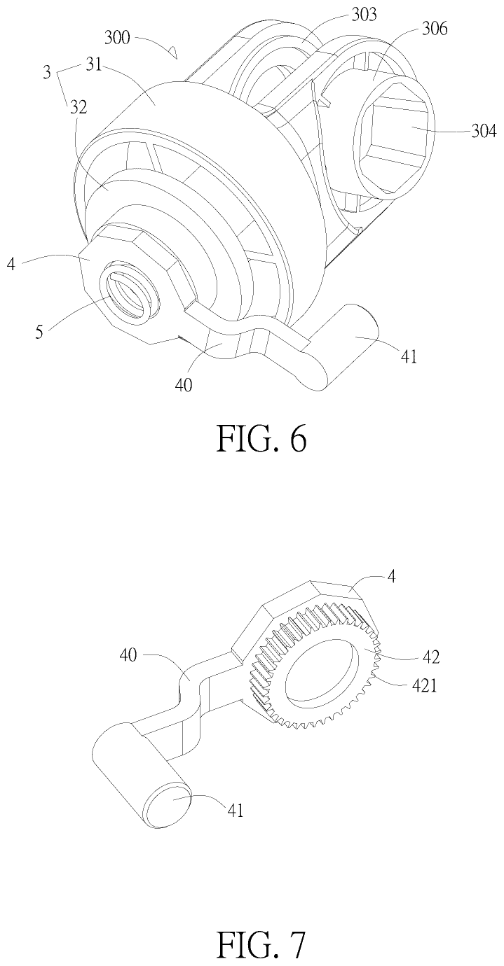

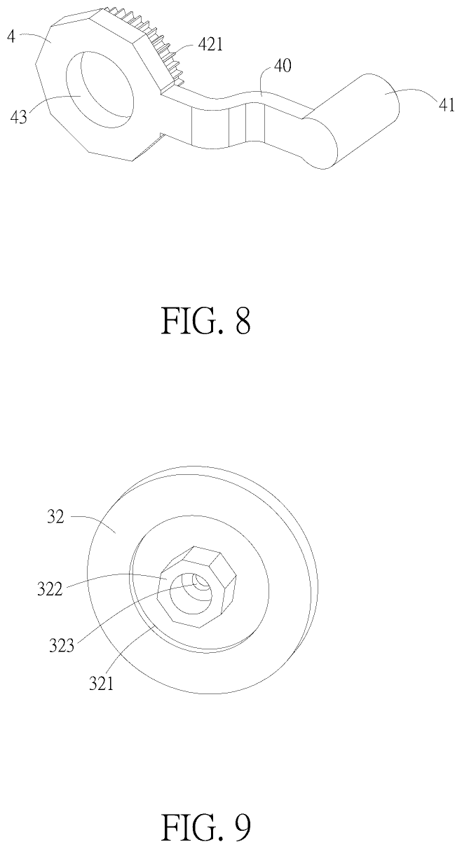

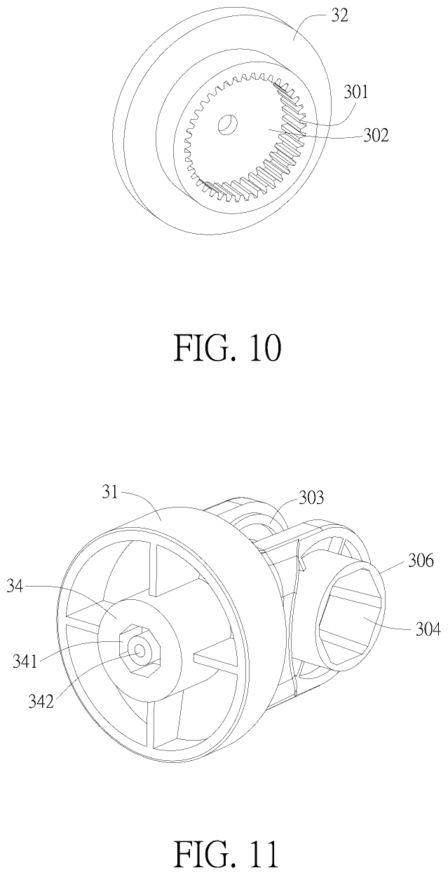

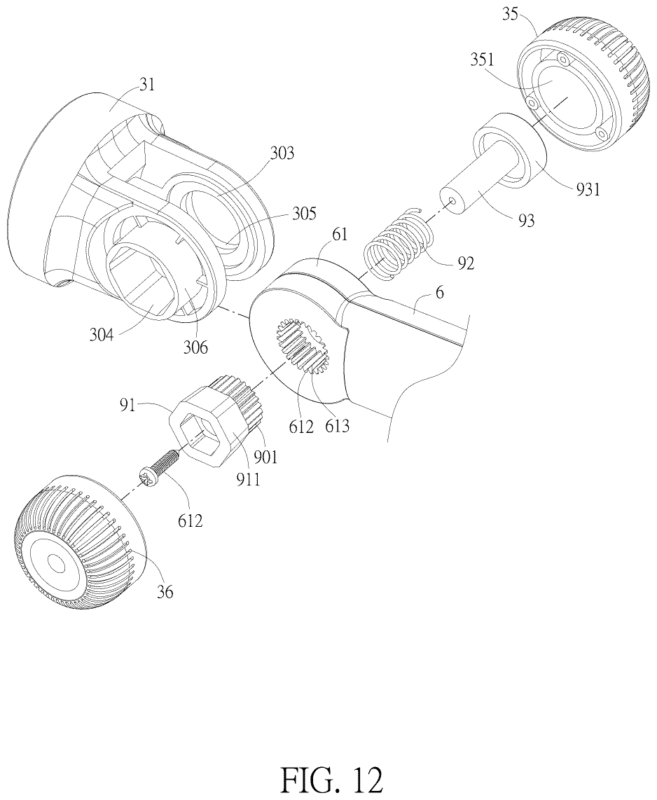

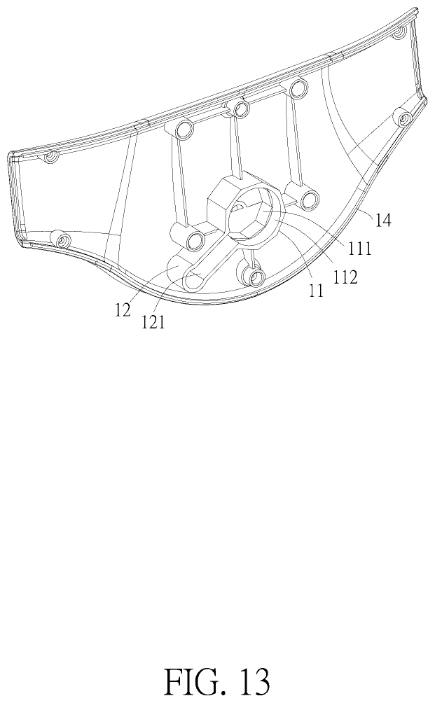

Referring to FIGS. 1-15, a hands-free and multi-angle adjustable adult product device is provided, which comprises: a support member (1), a wearing structure (2), a rotation adjustment mechanism (300), a connecting arm (600), and an adult product tool (8). The wearing structure (2) is mounted on the support member (1) and works together with the support member (1) to be secured to the human body. The rotation adjustment mechanism (300) is mounted on the support member (1) and can rotate relative to the support member (1) around the X-axis to adjust the angle. The connecting arm (600) connects the rotation adjustment mechanism (300) to the adult product tool (8) or a holder (80) for fixing and mounting the adult product tool (8). The connecting arm (600) can also rotate relative to the rotation adjustment mechanism (300) around the Z-axis to adjust the angle. Ultimately, the adult product tool (8) can rotate relative to the support member (1) around the X-axis and the Z-axis to adjust its angle, meeting usage requirements. This configuration allows the adult product tool (8) to be stably mounted on the human body while its position and angle relative to the body can be adjusted, ensuring that the adult product tool (8) is positioned at a predetermined location for convenient use without requiring the user to hold the tool (8) with both hands constantly. This hands-free functionality not only eliminates hand fatigue caused by holding the tool (8) but also improves the user experience, allowing the user to perform other tasks with their hands, thereby making the tool extremely convenient to use.

The rotation adjustment mechanism (300) comprises a rotating component (3) mounted on the support member (1) and capable of rotating around the X-axis to adjust the angle, a locking component (4) mounted movably back and forth (in the X-axis direction) within the support member (1), and an elastic component (5) located between the inner wall of the support member (1) and the locking component (4). In the normal state, the elastic component (5) provides elastic force to the locking component (4), which engages and locks with the rotating component (3) under the elastic force of the elastic component (5). At this time, the rotating component (3) cannot rotate relative to the support member (1), ensuring that the rotation adjustment mechanism (300) is locked or fixed to the support member (1) with a stable assembly structure. An unlock button (41) connected to the locking component (4) is exposed on the surface of the support member (1) for convenient pressing of the unlock button (41) later. When the unlock button (41) is pressed, the entire locking component (4) is driven to move backward to disengage from the rotating component (3), allowing the rotating component (3) to rotate relative to the support member (1) to adjust the angle. At this time, the elastic component (5) is in a compressed state. Once the rotating component (3) is rotated relative to the support member (1) to the desired position, releasing the unlock button (41) causes the locking component (4) to be pushed forward by the elastic force of the elastic component (5), re-engaging and locking the rotating component (3). This operation is extremely simple and convenient.

In this embodiment, the elastic component (5) is a spring.

The support member (1) is equipped with a mounting cylinder (11). The mounting cylinder (11) contains a first polygonal groove (111), and its opening is provided with a circular groove (112) that communicates with the first polygonal groove (111). The locking component (4) has a polygonal cross-section compatible with the first polygonal groove (111), and it is embedded in the first polygonal groove (111) to allow back-and-forth movement (in the X-axis direction). However, the locking component (4) cannot rotate, ensuring its stable installation within the first polygonal groove (111). The rear end of the rotating component (3) is circular and embedded in the circular groove (112), allowing it to rotate around the X-axis.

The support member (1) is further equipped with a guide cylinder (12). The guide cylinder (12) comprises a sliding guide groove (121) that communicates with the first polygonal groove (111) of the mounting cylinder (11). A connecting rod (40) integrally connects the locking component (4) to the unlock button (41). The rear end of the connecting rod (40) and the unlock button (41) are configured to be mounted within the sliding guide groove (121), ensuring stable installation within the sliding guide groove (121) while allowing stable back-and-forth sliding within the groove. The locking component (4), connecting rod (40), and unlock button (41) form an integrated, non-detachable assembly. When the unlock button (41) is pressed, it directly drives the locking component (4) backward within the sliding guide groove (121), compressing the elastic component (5) and disengaging the locking component (4) from the rotating component (3). This achieves the purpose of unlocking the rotating component (3).

The specific assembly structure between the rotating component (3) and the locking component (4) is as follows: The rear end of the rotating component (3) is provided with a first locking groove (301), and the inner wall of the first locking groove (301) is equipped with multiple first locking teeth (302). The front end of the locking component (4) is provided with a locking protrusion (42) that fits the first locking groove (301). The outer surface of the locking protrusion (42) is equipped with second locking teeth (421) that engage the first locking teeth (302). When the locking protrusion (42) is inserted into the first locking groove (301), the second locking teeth (421) engage with the first locking teeth (302), locking the rotating component (3) at the front end of the locking component (4). This prevents the rotating component (3) from rotating relative to the support member (1), ensuring that the rotating component (3) is fixed to the front end of the support member (1) and providing stable support and positioning for the connecting arm (600).

The rotating component (3) consists of a rotating base (31) and a rotating plate (32) fixed to the rear end of the rotating base (31) via a first screw (33). The rear end of the rotating base (31) is mounted in a first rotation groove (101) located on the surface of the support member (1). The rotating plate (32) is located inside the support member (1), and the rotating base (31) and rotating plate (32) are installed on the support member (1) by clamping them together in a front-to-back manner, forming a rotatable assembly. The rear end of the rotating plate (32) is equipped with the first locking groove (301).

The rear end of the rotating plate (32) is circular and embedded in the circular groove (112), allowing it to rotate around the X-axis.

The rear end of the locking component (4) is provided with a first recess (43), into which one end of the elastic component (5) is embedded, ensuring the stability of the assembly structure.

The rear end of the rotating base (31) is equipped with a convex seat (34), which passes through a second shaft hole (103) in the support member (1) and connects to the rotating plate (32). The convex seat (34) is further provided with a second polygonal groove (341) and a threaded hole (342) located at the center of the second polygonal groove (341). The front end of the rotating plate (32) is equipped with a first limiting groove (321) that fits the convex seat (34), as well as a polygonal convex ring (322) located at the center of the first limiting groove (321). The center of the polygonal convex ring (322) features a countersunk hole (323) for installing the first screw (33). The convex seat (34) of the rotating base (31) is embedded in the first limiting groove (321), and the polygonal convex ring (322) is embedded in the threaded hole (342). The countersunk hole (323) corresponds to the threaded hole (342), and the first screw (33) passes through the countersunk hole (323) and the threaded hole (342), securing the rotating base (31) and the rotating plate (32) together such that they cannot rotate relative to each other.

The support member (1) comprises a front shell (13) and a rear shell (14) fixed to the rear end of the front shell (13). The front shell (13) and the rear shell (14) are secured together with screws. The front end of the rear shell (14) is equipped with a guide cylinder (12) and a mounting cylinder (11). The front end of the front shell (13) is equipped with the first rotation groove (101), the second shaft hole (103), and a window (102) for the unlock button (41) to pass through.

The wearing structure (2) comprises a first binding strap (21) and a second binding strap (22). One end of the first binding strap (21) is fixed to one side of the support member (1), and one end of the second binding strap (22) is fixed to the other side of the support member (1). The other ends of the first binding strap (21) and the second binding strap (22) are secured together via magnetic attraction, snap fasteners, or Velcro to form a wearing space with the support member (1). In this embodiment, the other ends of the first binding strap (21) and the second binding strap (22) are secured with Velcro for easy assembly and disassembly, as well as stable connection. The front shell (13) is provided with a first positioning post (131) and a second positioning post (132). The other end of the first binding strap (21) is provided with a first positioning hole (211), and the other end of the second binding strap (22) is provided with a second positioning hole (221). The first positioning hole (211) and the second positioning hole (221) respectively fit over the first positioning post (131) and the second positioning post (132). Both sides of the front shell (13) and rear shell (14) clamp and fix the other ends of the first binding strap (21) and the second binding strap (22), ensuring their stable installation on both sides of the front shell (13) and rear shell (14).

The specific structure of the connecting arm (600) is described in detail below.

The connecting arm (600) comprises at least two segments, including a first arm (6) and a second arm (7), assembled together and capable of rotating around the Z-axis to adjust the angle. The first arm (6) is mounted on the rotating component (3) and can rotate around the Z-axis to adjust the angle. The distal end of the second arm (7) is equipped with an adult product tool (8) or a holder (80) for securing and mounting the adult product tool (8). In other words, the adult product tool (8) can also rotate around the Z-axis through the connecting arm (600) to adjust the angle, meeting various usage requirements.

The first arm (6) and the rotating component (3) are connected through a joint assembly (9) to form a rotatable connection. The front end of the rotating component (3) is equipped with a pivot hole (303), and both sides of the rotating component (3) are provided with polygonal anti-rotation grooves (304) and first holes (305) that communicate with the pivot hole (303). The rear end of the first arm (6) is equipped with a pivot section (61), which comprises a first shaft hole (611) running through its sides. The inner wall of one side of the first shaft hole (611) is equipped with a second locking groove (612), and the inner wall of the second locking groove (612) is provided with multiple third locking teeth (613).

The joint assembly (9) comprises an anti-rotation locking block (91), a first spring (92), and a shaft rod (93). The anti-rotation locking block (91) comprises a polygonal anti-rotation section (911) and a locking section (912). The locking section (912) is equipped externally with multiple fourth locking teeth (901) that fit the third locking teeth (613). The polygonal anti-rotation section (911) is embedded in the polygonal anti-rotation groove (304), and the locking section (912) is inserted into the second locking groove (612), with the fourth locking teeth (901) engaging with the third locking teeth (613). One end of the shaft rod (93) is formed into a button section (931), while the other end of the shaft rod (93) passes through the first hole (305), pivot hole (303), and first shaft hole (611) to connect with the locking section (912). It is secured to the locking section (912) via a second screw (910). The first spring (92) is sleeved over the shaft rod (93), with both ends of the spring (92) pressing against the button section (931) and the pivot section (61), respectively, and is in a compressed state. In normal use, the polygonal anti-rotation section (911) of the anti-rotation locking block (91) is embedded in the polygonal anti-rotation groove (304) of the rotating component (3), and the locking section (912) is inserted into the second locking groove (612) of the pivot section (61), with the fourth locking teeth (901) engaging the third locking teeth (613). This locks the pivot section (61) within the pivot hole (303) of the rotating component (3), preventing relative rotation. When it is necessary to adjust the angle by rotating the first arm (6) relative to the rotating component (3) around the Z-axis, the button section (931) is pressed to drive the shaft rod (93) to move, compressing the first spring (92). This action causes the polygonal anti-rotation section (911) to disengage from the polygonal anti-rotation groove (304), and the fourth locking teeth (901) disengage from the third locking teeth (613), achieving the unlocking state. The first arm (6) can then rotate relative to the rotating component (3) around the Z-axis to adjust to the desired position. Once the button section (931) is released, the first spring (92) resets, driving the shaft rod (93) and the anti-rotation locking block (91) back into position. The locking section (912) re-inserts into the second locking groove (612), and the fourth locking teeth (901) re-engage with the third locking teeth (613), achieving the locking state.

The opening size of the polygonal anti-rotation groove (304) is larger than the inner cavity size, and the outer end of the polygonal anti-rotation section (911) is larger than its inner end.

The front end of the rotating component (3) is further equipped with a first end cover (35) and a second end cover (36) on both sides. The first end cover (35) encloses the outer area of the shaft rod (93) and its button section (931). The first end cover (35) comprises a first sliding hole (351) in which the button section (931) is configured to slide, with the button section (931) exposed on the surface of the first end cover (35). The second end cover (36) covers the anti-rotation locking block (91), ensuring aesthetic appearance while providing protection for the assembly.

Both the first end cover (35) and the second end cover (36) are fixed to the front end of the rotating component (3) via threaded connections. For example, both sides of the front end of the rotating component (3) are equipped with convex rings (306) whose outer surfaces are provided with external threads. Correspondingly, the inner surfaces of the first end cover (35) and the second end cover (36) are provided with internal threads, allowing the first end cover (35) and the second end cover (36) to be screwed onto the convex rings (306) through the engagement of the internal and external threads. This assembly structure is extremely simple. Additionally, the first end cover (35) and the second end cover (36) can also be fixed to the front end of the rotating component (3) using snap-on connections.

The assembly structure between the first arm (6) and the second arm (7) is identical to the assembly structure between the rotating component (3) and the first arm (6), achieving the same purpose of rotation around the Z-axis and locking, and will not be elaborated further here.

As shown in FIG. 1, the adult product tool (8) can rotate relative to the second arm (7) around the Z-axis to adjust its angle, making it more convenient to adjust the position of the adult product tool (8) relative to the body. This meets different usage requirements and enhances convenience.

The assembly structure between the second arm (7) and the adult product tool (8) is also identical to the assembly structure between the rotating component (3) and the first arm (6), achieving the same purpose of rotation around the Z-axis and locking, and will not be elaborated further here.

The adult product tool (8) in this embodiment is a male masturbator.

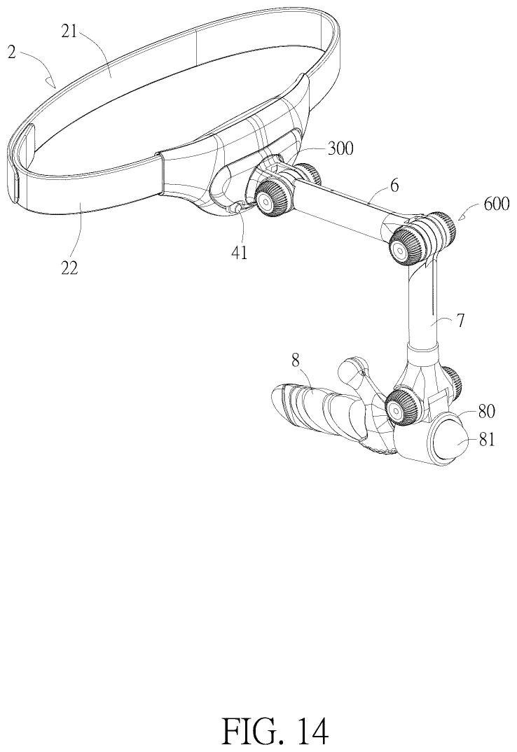

Of course, the adult product tool (8) can also be a female vibrator. As shown in FIG. 14, the adult product tool (8) is fixed by a holder (80). The holder (80) can rotate relative to the second arm (7) around the Z-axis to adjust its angle, making it more convenient to adjust the position of the adult product tool (8) relative to the body. This meets different usage requirements and enhances convenience. The assembly structure between the second arm (7) and the holder (80) is also identical to the assembly structure between the rotating component (3) and the first arm (6), achieving the same purpose of rotation around the Z-axis and locking, and will not be elaborated further here. The holder (80) is a ring-shaped sleeve into which the handle portion (81) of the vibrator is inserted and secured, thereby fixing the adult product tool (8) with the holder (80). Of course, the holder (80) can have other structures, as long as it can secure the adult product tool (8).

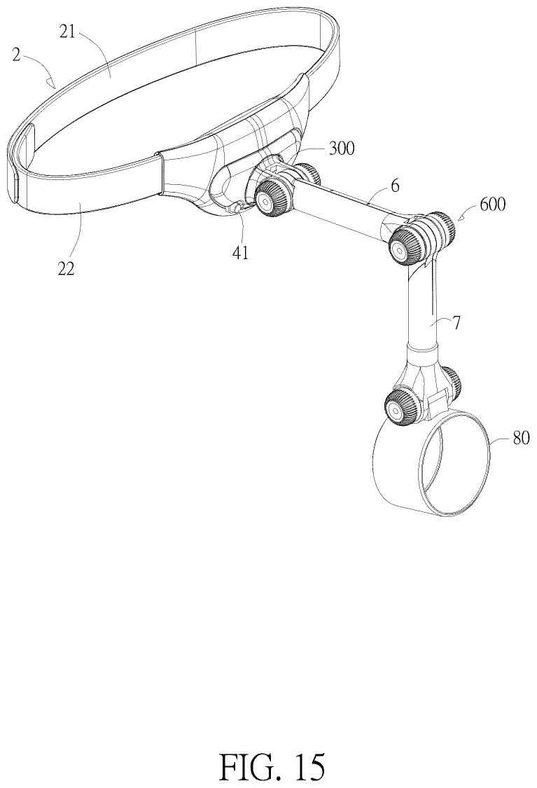

As shown in FIG. 15, the size of the holder (80) can be made larger to accommodate other larger adult product tools (8), meeting different usage requirements.

In summary, when in use, the wearing structure works in conjunction with the support member to secure the device to the human body. The adult product tool can rotate relative to the support member around the X-axis via the rotation adjustment mechanism to adjust its angle. It can also rotate relative to the rotation adjustment mechanism around the Z-axis via the connecting arm to adjust its angle, achieving multi-angle adjustment. This enables the adult product tool to be positioned at a predetermined location for convenient use, eliminating the need for the user to hold it constantly with both hands. This hands-free functionality not only prevents hand fatigue caused by holding the adult product tool but also enhances the user experience, allowing the user to perform other tasks with their hands, thus significantly improving convenience.

Of course, the above description is merely specific embodiments of the invention and does not limit its scope. Any equivalent modifications or alterations made according to the structure, features, and principles described in the claims of this invention should be comprised within the scope of the invention.

I claim

1. A hands-free and multi-angle adjustable adult product device, comprising:
a support member, wherein the support member is provided with a wearing structure for securing the device to the human body;
a rotation adjustment mechanism, comprising a rotating component mounted on the support member and capable of rotating around the X-axis to adjust the angle, a locking component installed in the support member and capable of moving back and forth, and an elastic component disposed between the inner wall of the support member and the locking component, wherein the locking component engages and locks with the rotating component under the elastic force of the elastic component, and the locking component is connected to an unlock button exposed on the surface of the support member; when the unlock button is pressed, the locking component moves backward to disengage from the rotating component, allowing the rotating component to rotate relative to the support member to adjust the angle;
a connecting arm, comprising at least two segments assembled together and capable of rotating around the Z-axis to adjust the angle, wherein a first arm is mounted on the rotating component and can rotate around the Z-axis to adjust the angle, and the distal end of a second arm is provided with an adult product tool or a holder for securing and mounting the adult product tool.

2. The hands-free and multi-angle adjustable adult product device according to claim 1, wherein the rear end of the rotating component is provided with a first locking groove, and the inner wall of the first locking groove is equipped with multiple first locking teeth; the front end of the locking component is provided with a locking protrusion adapted to the first locking groove, and the outer surface of the locking protrusion is provided with second locking teeth adapted to the first locking teeth; when the locking protrusion is inserted into the first locking groove, the second locking teeth engage with the first locking teeth, thereby locking the rotating component at the front end of the locking component.

3. The hands-free and multi-angle adjustable adult product device according to claim 2, wherein the support member is provided with a mounting cylinder; the mounting cylinder comprises a first polygonal groove, and the opening of the mounting cylinder is provided with a circular groove communicating with the first polygonal groove; the locking component has a polygonal cross-section adapted to the first polygonal groove, and the locking component is embedded in the first polygonal groove to allow back-and-forth movement; the rear end of the rotating component is circular and embedded in the circular groove to allow rotation.

4. The hands-free and multi-angle adjustable adult product device according to claim 2, wherein the support member is further provided with a guide cylinder; the guide cylinder comprises a sliding guide groove communicating with the first polygonal groove of the mounting cylinder; a connecting rod integrally connects the locking component to the unlock button, and the rear end of the connecting rod and the unlock button are configured to be installed in the sliding guide groove.

5. The hands-free and multi-angle adjustable adult product device according to claim 2, wherein the rotating component comprises a rotating base and a rotating plate fixed to the rear end of the rotating base via a first screw; the rear end of the rotating base is mounted in a first rotation groove provided on the surface of the support member; the rotating plate is located inside the support member, and the rotating base and the rotating plate are installed on the support member by clamping the rotating base and the rotating plate together in a front-to-back manner, forming a rotatable assembly; the rear end of the rotating plate is provided with the first locking groove.

6. The hands-free and multi-angle adjustable adult product device according to claim 5, wherein the rear end of the rotating base is provided with a convex seat; the convex seat is further provided with a second polygonal groove and a threaded hole located at the center of the second polygonal groove; the front end of the rotating plate is provided with a first limiting groove adapted to the convex seat and a polygonal convex ring located at the center of the first limiting groove, wherein the center of the polygonal convex ring comprises a countersunk hole for mounting the first screw; the convex seat of the rotating base is embedded in the first limiting groove, and the polygonal convex ring is embedded in the threaded hole; the countersunk hole corresponds to the threaded hole, and the first screw passes through the countersunk hole and the threaded hole to secure the rotating base and the rotating plate together, preventing relative rotation.

7. The hands-free and multi-angle adjustable adult product device according to claim 1, wherein the support member comprises a front shell and a rear shell fixed to the rear end of the front shell; the wearing structure comprises a first binding strap and a second binding strap, wherein one end of the first binding strap is fixed to one side of the support member, and one end of the second binding strap is fixed to the other side of the support member; the other ends of the first and second binding straps are secured together via magnetic attraction, snap fasteners, or Velcro, forming a wearing space with the support member.

8. The hands-free and multi-angle adjustable adult product device according to claim 1, wherein the first arm and the rotating component are connected through a joint assembly to form a rotatable connection; the front end of the rotating component is provided with a pivot hole, and both sides of the rotating component are provided with polygonal anti-rotation grooves and first holes communicating with the pivot hole; the rear end of the first arm is provided with a pivot section, which comprises a first shaft hole running through its sides, and the inner wall of one side of the first shaft hole is provided with a second locking groove, wherein the inner wall of the second locking groove is equipped with multiple third locking teeth; the joint assembly comprises an anti-rotation locking block, a first spring, and a shaft rod, wherein the anti-rotation locking block comprises a polygonal anti-rotation section and a locking section, and the locking section is provided externally with multiple fourth locking teeth adapted to the third locking teeth; the polygonal anti-rotation section is embedded in the polygonal anti-rotation groove, and the locking section is inserted into the second locking groove, with the fourth locking teeth engaging the third locking teeth; one end of the shaft rod is formed as a button section, and the other end of the shaft rod passes through the first hole, pivot hole, and first shaft hole to connect with the locking section, secured to the locking section via a second screw; the first spring is sleeved over the shaft rod, with both ends pressing against the button section and the pivot section, respectively, and is in a compressed state.

9. The hands-free and multi-angle adjustable adult product device according to claim 8, wherein the front end of the rotating component is further provided with a first end cover and a second end cover on both sides; the first end cover encloses the shaft rod and its button section, and comprises a first sliding hole in which the button section is configured to slide, exposed on the surface of the first end cover; the second end cover encloses the anti-rotation locking block; the assembly structure between the first arm and the second arm is identical to the assembly structure between the rotating component and the first arm.

10. The hands-free and multi-angle adjustable adult product device according to claim 8, wherein the adult product tool or holder can rotate relative to the second arm around the Z-axis to adjust the angle, and the assembly structure between the second arm and the adult product tool or holder is identical to the assembly structure between the rotating component and the first arm.
